(19) United States
(12) Patent Application Publication
(10) Pub. No.: US 2003/0038070 A1
(43) Pub. Date: Feb. 27, 2003

(54) Use of plastics panels in sewage treatment

(76) Inventors: Gerhard Hocke, Rossdorf (DE); Britta Johanning, Darmstadt (DE); Volker Benz, Hochst (DE); Andreas Rudiger, Scharbeutz (DE)

Correspondence Address: BAYER CORPORATION, PATENT DEPARTMENT, 100 BAYER ROAD, PITTSBURGH, PA, 15205, US

(21) Appl. No.: 10/224,258

(22) Filed: Aug. 20, 2002

(30) Foreign Application Priority Data
Aug. 22, 2001 (DE) 10141211.8

(51) Int. Cl. C02F 3/12

(52) U.S. Cl. 210/220

(57) ABSTRACT

The invention relates to the use of special plastic panels comprising integrated cavities as what are termed separator plates for plate separators in sewage treatment.

### FIELD OF THE INVENTION

This invention relates to the use of special plastic panels comprising integrated cavities as to what are termed separator plates for plate separators in sewage treatment.

### BACKGROUND OF THE INVENTION

Various processes and apparatuses are known from the prior art by means of which the separation of biomass is effected in the aeration tank for the biological treatment of sewage.

What is termed the activated sludge process was developed as far back as 1914 (Experiments on the Oxidation of Sewage without the Aid of Filters; E. Ardern, W. T. Locket, The Evolution and Development of the Activated Sludge Process of Sewage Purification in Great Britain, 1914). The main components of this process, which even today is the most widely used process for sewage purification, are the aeration tank, in which substances which are contained in the water and which comprise microorganisms suspended in the sewage are reacted under appropriate conditions, and the final clarifier, in which the bacteria are separated from the water by sedimentation so that they can then be pumped back into the aeration tank.

In order to optimize the processes occurring in the aeration tank, plates in the form of a plate assembly (plate separator) are used. Part of the biomass is retained in the aeration tank by sedimentation. By using these so-called oblique, sheet or plate separators (which are also known as clarifiers or thickeners), the settlement area is considerably increased. The use of plate assemblies in the aeration tank for the activated sludge process is known, for example, from DE-C-4 329 239 and DE-A-19 800 664. One disadvantage of plate assemblies is that they are very heavy, and therefore, costly supporting and holding structures have to be installed in order to withstand the corresponding forces. This is a considerable disadvantage, particularly in deep aeration tanks. Moreover, the subsequent installation of plate assemblies in existing aeration tanks is very costly, and in addition, the tank has to be emptied.

### SUMMARY OF THE INVENTION

Therefore, the object of the present invention was to provide a structure for an aeration tank which has the advantage of a larger settlement area, and also avoids the construction of costly supporting and holding structures as well as any necessary reinforcement of the tank base.

It has proven possible to achieve this object by the use of plastic panels comprising integrated open and/or closed cavities as separator plates in what are termed plate separators. By using these special plastic panels, it is possible not only to considerably reduce the weight of the overall structure, but also to avoid the use of costly supporting and holding structures, as well as avoiding the reinforcement of the tank base of the aeration tank. Moreover, by varying the number of closed and open cavities in the plastic panels, it is possible to control the buoyancy effect on the separator and thus the weight.

The present invention therefore relates to the use of plastic panels comprising integrated open and/or closed cavities as separator plates for plate separators in sewage treatment.

### DETAILED DESCRIPTION OF THE INVENTION

The plastics panels containing integrated cavities which are used have a weight per unit area of <5 kg/m², preferably of 0.8 to 4 kg/m², most preferably of 1.5 to 3 kg/m². The preferred panel thickness is 4 to 50 mm, most preferably 8 to 32 mm.

By using the plastics panels of the present invention comprising integrated cavities, in which all or only part of which are closed, the plastics panels are additionally subjected to a buoyancy effect when used in the aeration tank, so that the weight of the structure is additionally reduced.

The plastic panels of the present invention containing integrated cavities are preferably double-wall or multiple-wall panels. M-shaped, X-shaped or similar structures are also possible.

The plastics panels containing integrated cavities can be made of polycarbonate, polystyrene, polymethyl methacrylate, polyethylene, polypropylene, polyvinyl chloride, polyester, acrylonitrile-butadiene-styrene and blends thereof.

Despite the low weight of the plastic panels comprising integrated cavities which are used, they have an adequate mechanical rigidity for this application.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An aeration tank comprising panels which comprise integrated, open and/or closed cavities.

2. An aeration tank according to claim 1, wherein said panels comprise a weight per unit area of <5 kg/m².

3. An aeration tank according to claim 1, wherein said panels are double-wall or multi-wall panels.

4. An aeration tank according to claim 1, wherein said panels are comprised of plastic materials.

5. An aeration tank according to claim 4, wherein said plastic materials are selected from the group consisting of polycarbonate, polystyrene, polymethyl methacrylate, polyethylene, polypropylene, polyvinyl chloride, polyester, acrylonitrile-butadiene-styrene and blends thereof.

6. A panel manufactured from plastic materials which are used as plate separators in an aeration tank for sewage treatment, said panel comprising integrated, open and/or closed cavities as separator plates.

7. A panel according to claim 6, wherein said panels comprise a weight per unit area of <5 kg/m².

8. A panel according to claim 6, wherein said panels are double-wall or multi-wall panels.

9. A panel according to claim 6, wherein said panel are comprised of plastic materials.

10. A panel according to claim 9, wherein said plastic materials are selected from the group consisting of polycarbonate, polystyrene, polymethyl methacrylate, polyethylene, polypropylene, polyvinyl chloride, polyester, acrylonitrile-butadiene-styrene and blends thereof.

11. An aeration tank according to claim 1, wherein between the panels there are mechanical installations which act as hydraulic resist to the water that passes through the tank.
